(19) United States
(12) Patent Application Publication
(10) Pub. No.: US 2011/0164222 A1
(43) Pub. Date: Jul. 7, 2011

(54) IMAGE LIGHTING SYSTEM WITH AN ART SENSE

(76) Inventor: Young-Joon Noh, Incheon (KR)

(21) Appl. No.: 12/593,672

(22) PCT Filed: Jul. 20, 2008
(86) PCT No.: PCT/KR2008/004235

§ 371 Date: Sep. 29, 2009

(51) Int. Cl. G03B 21/14

(52) U.S. Cl. 353/31

(57) ABSTRACT

This invention relates to the image lighting system which can successively display the various kinds of images by the electronic circuit and generate the images by the image projector. This system has the characteristic comprising the plurality of LED, the electronic circuit part, the light-emitting part, the image projector, and the light fixture part.

### TECHNICAL FIELD

This invention relates to the image lighting system with an art sense using the electronic circuit and design.

2. Background Art

This invention has two technical differences comparing with other lighting system. First, the technique that expresses the various colorful light consecutively and successively.

Second, especially the technique that applies the image projector designed for an art image.

Accordingly, this invention proposes the new technical improvement in field of art lighting system in emerging from the former lighting concept. Up to date in the lighting system there is not the image lighting system with an art sense but there is only the simple variation system of the color illumination.

### DISCLOSURE OF THE INVENTION

### Technical Problem

To realize this invention we have the problems as follows;

1. A constitution of an electronic circuit that makes a plurality of LED operate in order.

2. The pertinent selection and configuration of LED for the image expression that we want.

3. The LED drive amplifier that operates to the maximum current condition.

4. The adequate design of an image projector that can propose an art image.

### Technical Solution

For the achievement of prescribed object this invention comprises four parts as follows; an electronic circuit part which operates with multistage; a light-emitting part which is derived by the transistor amplifier; an image projector part which projects the various images; the light fixture part which expresses the images.

An electronic circuit part is composed with the pulse generator that generates pulses at regular intervals, the devide-by-16 counter that generates 4 bits binary code whenever the pulses are input from the pulse generator and the transistor amplifier that drives the LED. Accordingly 4 bits binary code changes with 16 stages each pulse.

An light-emitting part that emits light of various kinds of color necessitates the pertinent selection and configuration of the LED to realize an art image each stage.

An image projector part plays the important role for expressing the images through LED light and must be adequately designed.

An light fixture part has to appear an image information on the outside clearly.

### Advantageous Effects

The kernel of this invention is the application of the image projector. On account of the image projector the lighting device makes possible to have an art sense. Increasingly each stage the different images are offered inducing the position change of the LED which is operated. And also we can generate the various kinds of images according to change the combination of the LED and the shape of the image projector as we hoped.

### BRIEF DESCRIPTION OF THE DRAWINGS

FIG. 1 is an example of an image projector according to this invention.

FIG. 2 and FIG. 3 are examples that are made a sketch of an art image.

FIG. 4 is an example of a plane figure of this invention.

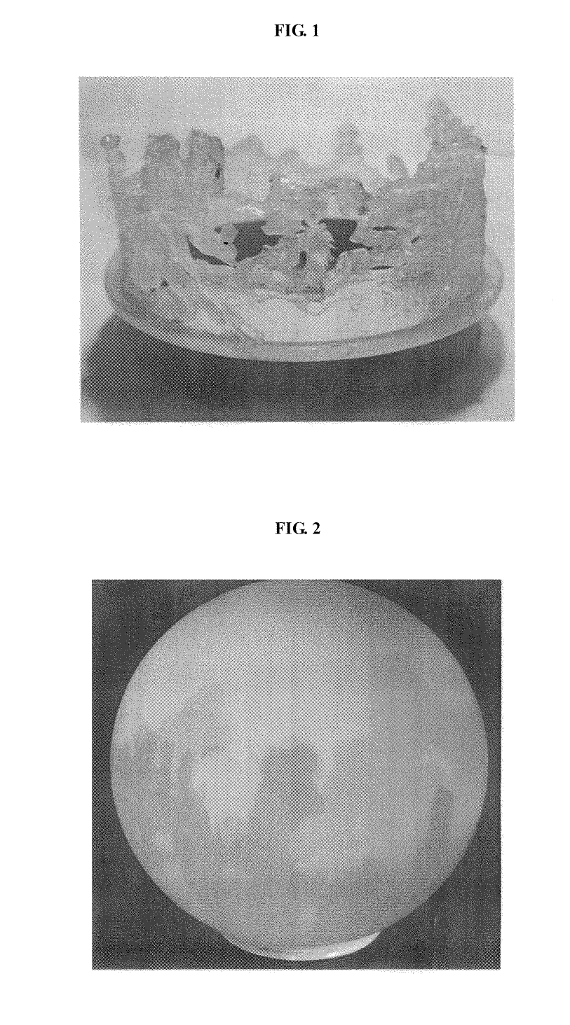

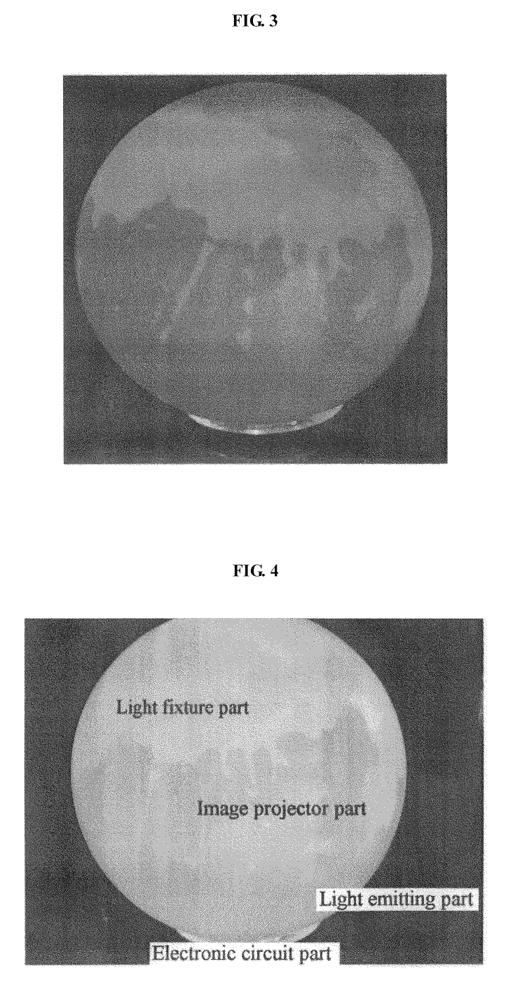

### BEST MODE FOR CARRYING OUT THE INVENTION

As this invention takes the prescribed point into account, it has the characteristics which are constituted with the electronic circuit part which operates with multistage; the light-emitting part which is drived by the transistor amplifier; the image projector part which projects the various images; the light fixture part which expresses the images.

The electronic circuit part is composed with the pulse generator that generates pulses at regular intervals, the devide-by-16 counter that generates 4 bits binary code whenever the pulses are input from the pulse generator. and the transistor amplifier that drives the LED is connected to the output of the counter. Accordingly the 4 bits binary code change with 16 stages each pulse.

The light-emitting part that emits light of various kinds of color necessitates the pertinent selection and configuration of the LED to realize an art image each stage. Especially, the LED utilizes the hyper-bright four angle LED of the SMT type which has 120° wide angle to realizing with more efficiency the art images. The 5-phi high brightness LED can be used in any case.

The image projector part plays the important role for expressing the images through the LED light and must be adequately designed. This image projector are configured on the lower part of the lighting system and can be designed at will. Even if the image projector is the simple shape it can variously propose the images in three dimensions in response to illuminating with various different angle through the LED which are configured circularly.

The light fixture part is to appear an image information on the outside clearly. The light fixture must use the glass or plastic material which takes a round shape or an oval of the semitransparent milk color and its inside is coated uniformly.

The businessmen related to the above-mentioned contents will know what the various change and modification are possible in the scope that does not deviate from the technology phenomenon.

Accordingly, the technical scope is not be limited to the contents which are described in the operation examples but must be determined by the patent claim range and its equal subjects.

Mode for Invention

First of all the electronic circuit part is composed by PCB art work, the SMT type LED is connected to the output of the devide-by-16 counter, the image projector is configured at the upside of the LED, and the light fixture of the milk color are configured over the image projector.

The power supply is converted to D.C by adopter, generally D.C power supply is used from 5 V to 12V. Also the output power of this invention can be used from low power to high power as one wants.

### INDUSTRIAL APPLICABILITY

The lighting device in modern times must add the art sense. To having the art sense in the lighting system we have to graft a design on the lighting system. This invention used the image projector to realizing the purpose and hereby will open up a new path of the lighting technology. Provided that we applicate this invention in all lighting system of the indoor and outdoor an high elegance in a lighting circumstance will be presented to us.

What is claimed is:

1. The image lighting system with an art sense which has the characteristic comprising the electronic circuit part which operates with multistage; the light-emitting part which is drived by the transistor amplifier; the image projector part which projects the various images; and the light fixture part which expresses the images.
The electronic circuit part is composed with the pulse generator that generates pulses at regular intervals, the devide-by-16 counter that generates 4 bits binary code whenever the pulses are input from the pulse generator, and the transistor amplifier that drives LED. Accordingly 4 bits binary code changes with 16 stages each pulse.
The light-emitting part that emits light of various kinds of color necessitates the pertinent selection and configuration of the LED to realize an art image each stage. Especially, the LED utilizes the hyper-bright four angle LED of the SMT type which has 120° wide angle to realizing with more efficiency the art images. The 5-phi high brightness LED can be used in any case.
The image projector part plays the important role for expressing the images through the LED light and must be adequately designed. This image projector are configured on the lower part of the lighting system and can be designed at will. Even if the image projector is the simple shape it can variously propose the images in three dimensions in response to illuminating with various different angle through the LED which are configured circularly.
The light fixture part is to appear an image information on the outside clearly. The light fixture must use the glass or plastic materials which takes a round shape or an oval of the semitransparent milk color and its inside is coated uniformly.

2. The image lighting system with an art sense which has the characteristic that can generate various kinds of images according to change the combination of the LED and the shape of the image projector as we hoped.
